(19) United States
(12) Patent Application Publication
(10) Pub. No.: US 2001/0037592 A1
(43) Pub. Date: Nov. 8, 2001

(54) TAPE-LOOP DISPLAY PANEL

(75) Inventor: MICHEL BERREBI, PARIS (FR)

Correspondence Address: NIXON & VANDERHYE, 1100 NORTH GLEBE ROAD 8TH FLOOR, ARLINGTON, VA, 222014714

(73) Assignee: Ouragan Communications Inc

(21) Appl. No.: 09/155,867

(22) PCT Filed: Jan. 30, 1998
(86) PCT No.: PCT/FR98/00179

§ 371 Date: None

(30) Foreign Application Priority Data
Feb. 11, 1997 (FR) 97/01556

(51) Int. Cl. G03B 21/64; G09F 11/12

(52) U.S. Cl. 40/472

(57) ABSTRACT

This invention relates to a tape-loop display panel (4) that is stretched between two parallel drums (3, 33) which are mounted to rotate in a frame (2) and driven intermittently by an electric motor (11), whereby frame (2) comprises means (10) for lighting the portion of loop (4) that is shown, characterized in that tape loop (4) is transparent and comprises transparent housings (9), or pouches, that are intended to receive information displays or supports.

This invention relates to a tape-loop display panel. The invention relates more particularly to a tape-loop display panel that is driven in rotation while pausing when the displays, for example advertising displays, that are carried by the tape loop are opposite a display window.

Strip display panels that make it possible for a strip comprising displays to unwind from a winding position on a lower roller to wind onto an upper roller are known from documents EP 0 253 033 and EP 0 048 353 in particular. In order to take into account the relative speed variations that the rollers need to have in order to keep the strip taut as it is being pulled, this type of panel in general comprises two drives and an electronic logic that ensure these variations. The devices for compensating for the roller speeds are complex and make these panels expensive.

Furthermore, the attachment of displays to the moving strip of the panels of the prior art is not very satisfactory. Actually, the displays are generally glued to the strips, and this makes it difficult to change the exposed displays quickly and repeatedly.

Devices with a tape loop that are driven by rotary rollers that comprise means for maintaining the tension of the loop are also known. These means for maintaining the tension of the loop, however, are complex and expensive.

An object of the invention is to propose a tape-loop display panel of simple structure that makes it possible to display interchangeable displays and overcomes the drawbacks of the prior art.

This object is achieved by virtue of the fact that the tape-loop display panel, which is stretched between two parallel drums that are mounted to rotate in a frame and driven intermittently by an electric motor, the frame comprises means for lighting the portion of the loop that is shown, whereby the tape loop is transparent and comprises transparent housings or pouches that are intended to receive information displays or supports.

According to another particular feature, the housings of the frame that are intended to hold the two ends of at least one of the drums are oblong, whereby the panel that comprises the means makes it possible to alter the position of the drum or drums in its oblong housings in order to make it possible to adjust the distance between the drums and thereby the tension of the tape loop.

According to another particular feature, the tape loop is equipped with position reference means that work with detection means that are located on the frame, whereby the loop drive means comprise adjustable timing means that ensure, by means of signals delivered by the detection means, the passage of the loop in such a way that each display is shown for a specified and adjustable length of time.

According to another particular feature, the means for detecting the reference position points of the loop consist of photoelectric means.

According to another particular feature, the tape loop is made of transparent plastic, transparent housings or pouches that are intended to receive information displays or supports that are each formed by a sheet of transparent plastic which is folded or attached at three of its edges against the tape loop and at regular intervals by bonding means.

According to another particular feature, the bonding means of the sheets that form the pouches on the tape loop consist of adhesive strips, whereby the lateral edges opposite the two adjacent sheets are attached to the tape loop by the same adhesive strips.

According to another particular feature, the bonding means of the sheets that form the pouches on the tape loop consist of thermobondings.

According to another particular feature, the means that make it possible to modify the position of the drum or drums in their oblong housings, in such a way as to make it possible to adjust the tension of the tape loop, consist of clamping systems that are screwed onto the frame, whereby each of the ends of the axis of the drum is mounted to pivot in an orifice of a respective clamp, and whereby the screwing and unscrewing of a screw for respective positioning of each clamp on the frame produce the translation of the clamp relative to the frame and ensure the translation of the drum in its oblong orifices.

According to another particular feature, the base of the frame of the panel comprises a starter switch of the panel, whereby the frame is integrated into a housing that comprises a pivoting cover that has an opening of a size which corresponds to the size of the displays that are placed in the pouches that are shown, whereby the pivoting action of the closing of the cover on the housing actuates the switch and ensures continuous operation of the panel by switching on the lighting means and intermittent drive means of the drums.

According to another particular feature, the tape loop comprises three adjacent pouches on its circumference.

According to another particular feature, the longitudinal size of the housing is greater than the distance that separates the outside generatrices of the drums, whereby this distance corresponds to 1.5 times the length of the displays.

Other particular features and advantages of this invention will be identified more clearly from reading the description below, which is given in reference to the accompanying drawings, where:

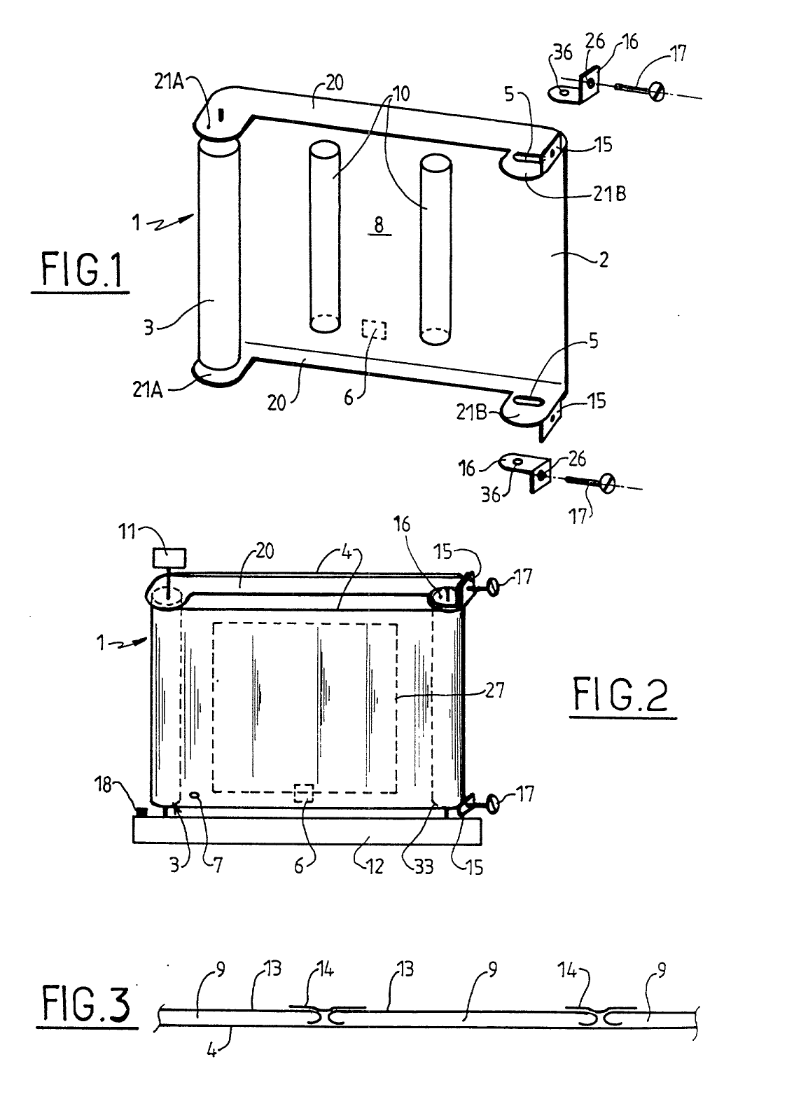

FIG. 1 presents a view in perspective, diagrammatic and partial, of the frame that carries the mechanisms of the display panel according to the invention,

FIG. 2 presents a perspective and diagrammatic view of the frame of the display panel of FIG. 1 on which a tape loop is mounted,

FIG. 3 presents a diagrammatic top view of a portion of the tape loop of the display panel of FIG. 2 that illustrates the housings according to the invention that are intended for information displays or supports.

The display panel according to the invention will now be described in reference to FIGS. 1 to 3. Panel (1) consists of a vertical frame (2) that is quite thin and is essentially parallelepipedic. Frame (2) is equipped with horizontal flanges (20) at its upper and lower horizontal edges. Flanges (20) are located on the same side of frame (2) that constitutes front face (8), or the face shown, of panel (1). The ends of each of two flanges (20) each form a short tab (21A, 21B) that is located in the plane of flange (20) in such a way that, in top view, flanges (20) are essentially U-shaped. The two pairs of tabs (21A, 21B), which are located at the ends of the two vertical edges of frame (2), are provided for mounting two cylindrical drums (3, 33) for driving an endless information support loop (4), whereby the axes of symmetry of drums (3, 33) are parallel to the vertical edges of frame (2). A first drum (3) is mounted to pivot and is fixed in translation between two tabs (21A) of a first pair of tabs. For this purpose, and in a known manner, two tabs (21A) are each equipped with an orifice that is provided for one end of the axis of drum (3). Each of tabs (21B) of the second tab pair is provided with an elongated orifice (5) or housing that is essentially parallel to the plane of face (8) in front of frame (2). Said elongated orifices (5) are intended for the ends of the axis of a second drum (33, FIG. 2). The elongated shape of orifices (5) allows the translation of second drum (33) relative to first drum (3), in addition to its rotation around its axis. Tabs (21B), which are provided with elongated orifices (5), also each comprise a flap-support (15) that is intended for mounting a clamping system (16) that makes it possible to adjust the position of second drum (33) in elongated orifices (5). Each of flap-supports (15) is located close to respective elongated orifice (5), on the edge of tab (21B) that forms the lateral end of flange (20). Flap-supports (15) are essentially perpendicular to the plane of flanges (20) and each oriented toward the outside of frame (20). Each flap-support (15) is provided with a hole that is intended for mounting, with a screw (17) or a nut (not shown), an L-shaped clamp (16). Each of the two faces of L-shaped clamp (6) is provided with an orifice (26, 36). A first orifice (26) of clamp (6) is provided for mounting, with a screw (17) and nut system, clamp (6) on respective flap-support (15). Second orifice (36) of clamp (6) is provided for the respective end of the axis of second drum (33, FIG. 2). Thus, each clamp (6) is mounted on a respective tab (21B), whereby second orifice (36) of each of clamps (6) is superimposed in respective elongated orifice (5). Then, second drum (33) is mounted to pivot by the two ends of its axis, through elongated orifices (5), into second orifices (36) of clamps (6). In this way, by tightening and loosening screws (17), the operator moves clamps (16) along elongated orifices (5) of tabs (21B). The movement of clamps (6) produces the movement of the ends of second drum (33) in elongated orifices (5). In this way, the operator can adjust the distance between second drum (33) and first drum (3) and thus the tension of a tape loop (4, FIG. 2), a display support, that is mounted between the latter. Tape loop (4), which is made of, for example, plastic, is transparent and comprises transparent housings (9, FIG. 3) or pouches (9) that are intended to receive information displays or supports. Transparent pouches (9), which are intended to receive information support displays, are each formed by a sheet (13) of transparent plastic that is folded and bonded against tape loop (4) at three of its edges. For example, adhesive strips (14) ensure the bonding of the edges of sheets (13) that form pouches (9). Advantageously, and as shown in FIG. 3, the vertical edges that are opposite two adjacent sheets (13) are bonded to loop (4) by the same adhesive strip of course, the invention is not limited to this sample embodiment. Thus, the adhesive bonding of sheets (13), which form pouches (9), can be replaced by a thermobonding or any other known means. Thus, by bonding the lower edge and the two lateral edges of each sheet (13) against tape loop (4), the opening of transparent pouch (9) is located at its upper edge. The operator thus can easily slide information support displays into the pouches. Tape loop (4) is mounted in frame (2) in such a way that the two parallel parts of stretched loop (4) are located on both sides of the vertical plane that contains parallelepipedic frame (2). Thus, a stretched portion of tape loop (4) passes opposite front face (8) of the panel, while a second stretched portion of the loop is located opposite the rear face of the frame (not shown in the figures). Front face (8) of the frame comprises means (10) for lighting the portion of loop (4) that is shown. These lighting means consist of, for example, neon lights (10) or any other light source. Panel (1) is equipped with intermittent means (11) for driving drums (3, 33) in rotation, whereby the drums in turn drive stretched tape loop (4) between the latter. For example, and in a known manner, an electric motor (11), located on upper flange (20), ensures the driving in rotation of first drum (3), and, by a known system of pulleys and belts, second drum (33) is also driven in rotation. Of course, other known means for driving drums (3, 33) can be used. Base (12) of frame (2) contains electronic circuits of the drive means of drums (3, 33), in particular known timing means (not shown) that ensure the intermittent driving of tape loop (4). For this purpose, the panel is equipped with means (6) for detecting the position of tape loop (4) that make it possible for the drive means to pause when the displays that are carried by tape loop (4) come opposite a display window. Detection means (6) consist of a photoelectric cell (8), which is located, for example, in the lower portion of front face (8) of frame (2) and detects reference points that are formed on loop (4). The position reference points that are formed on tape loop (4) consist of, for example, holes (7) that are provided on the lower edge of each of pouches (9). The timing means can be adjusted by the user to make it possible to select the duration of the pause that each display that is shown makes. Base (12) of frame (2) of the panel comprises a starter switch (18) of the display panel. Advantageously, frame (2) is intended to be accommodated in a housing (not shown) that comprises a pivoting cover that is provided with an opening (27), which is shown symbolically in FIG. 2 and which is of a size that corresponds to the size of the displays that are placed in pouches (9) that are shown. When frame (2) is to be accommodated in the housing, front face (8) of the frame is located opposite opening (27) of the cover of the housing. The housing can have, for example, essentially the shape of a television set housing. In a preferred and nonlimiting manner, the closing of the jointed cover of the housing actuates starter switch (18) of the panel. The actuation of switch (18) ensures the continuous operation of display panel (1) by switching on lighting means (10) and intermittent drive means (11) of drums (3, 33).

In a preferred embodiment of the display panel, transparent tape loop (4) comprises three pouches (9), which each have a height of approximately 50 cm and a width of approximately 38.5 cm. Consequently, the circumference of the tape loop will be on the order of 110 cm. The spacing of drums (3, 33) is determined by the circumference of tape loop (4), as well as by the diameter of said drums (3, 33). Frame (2) has dimensions that enable it to be accommodated in a housing that has a height of 70 cm, a width of 56 cm and a thickness of 13 cm. Of course, cover opening (27) of the housing has a size that corresponds to that of pouches (9). In a preferred, but by no means limiting manner, the longitudinal size of the housing is greater than the distance that separates the outside generatrices of drums (3, 33), whereby this distance separates the outside generatrices of drums (3, 33) corresponding to 1.5 times the length of the displays. Likewise, the adjustable timing of the drive means of loop (4) can be selected by the operator to be between 4 and 18 seconds, for example. It is clear that this preferred embodiment is in no way limiting. Thus, the number and the size of pouches (9) for displays that are carried by tape loop (4) can be different. In particular, tape loop (4) can carry more than three transparent pouches (9) for displays. The dimensions of tape loop (4) and of frame (2) are therefore adapted.

Other modifications within the grasp of one skilled in the art are also part of the spirit of the invention.

1. Tape-loop display panel (4) that is stretched between two parallel drums (3, 33), which are mounted to rotate in a frame (2) and driven intermittently by an electric motor (11), whereby frame (2) comprises means (10) for lighting the part of loop (4) that is shown, characterized in that tape loop (4) is transparent and comprises transparent housings (9), or pouches, that are intended to receive information displays or supports.

2. Display panel according to claim 1, wherein housings (5) of frame (2) that are designed for the two ends of at least one (33) of drums (3, 33) are oblong, whereby the panel that comprises means (15, 16, 17) makes it possible to modify the position of drum or drums (3, 33) in its oblong housings (5) to make it possible to adjust the distance between drums (3, 33) and thus the tension of tape loop (4).

3. Display panel according to claim 1 or 2, wherein tape loop (4) is equipped with position reference means (7) that works with detection means (6), which are located on frame (2), whereby drive means (11, 12) of loop (4) comprises adjustable timing means that ensure, by means of signals delivered by detection means (6), the passage of loop (4) in such a way that each display is shown for a specified and adjustable time.

4. Display panel according to claim 3, wherein means (6) for detecting the position reference points of loop (4) consist of photoelectric means.

5. Display panel according to one of claims 1 to 4, wherein tape loop (4) is made of transparent plastic, transparent housings (9) or pouches that are intended to receive information displays or supports that are each formed by a sheet (13) of transparent plastic that is folded or attached at three of its edges against tape loop (4) and at regular intervals by bonding means (14).

6. Display panel according to claim 5, wherein bonding means (14) of sheets (13) that form pouches (8) on tape loop (4) consist of adhesive strips (14), whereby the lateral edges opposite two adjacent sheets (13) are attached to tape loop (4) by the same adhesive strips.

7. Display panel according to claim 5, wherein bonding means (14) of sheets (13) that form pouches (9) on tape loop (4) consist of thermobondings.

8. Display panel according to claim 2, wherein means (15, 16, 17) that make it possible to modify the position of drum or drums (3, 33) in their oblong housings (6), in such a way as to make it possible to adjust the tension of tape loop (4), consist of clamping systems (16) that are screwed onto frame (2), whereby each of the ends of the axis of drum (33) is mounted to pivot in an orifice (36) of a respective clamp (16), and whereby the tightening and loosening of a screw (17) for respective positioning of each clamp (16) on frame (2) produces the translation of clamp (16) relative to frame (2) and ensures the translation of drum (33) in its oblong orifices (5).

9. Display panel according to one of claims 1 to 8, wherein base (12) of frame (2) of the panel comprises a starter switch (16) of the panel, whereby frame (2) is integrated into a housing that comprises a pivoting cover that is provided with an opening (27) of a size that corresponds to the size of the displays that are placed in pouches (9) that are shown, whereby the pivoting action of the closing of the cover on the housing actuates switch (18) and ensures continuous operation of the panel by switching on lighting means (10) and intermittent drive means (11) of drums (3, 33).

10. Display panel according to one of claims 1 to 9, wherein tape loop (4) comprises three adjacent pouches (9) on its circumference.

11. Display panel according to claim 9, wherein the longitudinal dimension of the housing is greater than the distance that separates the outside generatrices of drum (3, 33), whereby this distance corresponds to 1.5 times the length of the displays.
